(19) United States
(12) Patent Application Publication
(10) Pub. No.: US 2012/0138757 A1
(43) Pub. Date: Jun. 7, 2012

(54) SHOCK ABSORBER MOUNTING BRACKET REINFORCING STRUCTURE

(75) Inventors: Seok Gil Hong, Anyang-si (KR); Yong Kew Kim, Anyang-si (KR); Kyung Hee Lee, Hwaseong-si (KR)

(73) Assignees: Kia Motors Corporation, Seoul (KR); Hyundai Motor Company, Seoul (KR)

(21) Appl. No.: 13/270,681

(22) Filed: Oct. 11, 2011

(30) Foreign Application Priority Data
Dec. 7, 2010 (KR) 10-2010-0124506

(51) Int. Cl. B60G 7/02

(52) U.S. Cl. 248/205.1

(57) ABSTRACT

A shock absorber mounting bracket reinforcing structure is provided, which includes a shock absorber mounting bracket provided at a rear wheel house inner panel, and left and right reinforcing members which are provided on left and right sides of the shock absorber mounting bracket to support the left side and the right side of the shock absorber mounting bracket.

### CROSS-REFERENCE TO RELATED APPLICATION

This application is based on and claims priority from Korean Patent Application No. 10-2010-0124506 filed Dec. 7, 2010, the entire contents of which application is incorporated herein for all purposes by this reference.

### BACKGROUND OF INVENTION

1. Field of Invention

The present invention relates to a shock absorber mounting bracket reinforcing structure which can increase support strength of a shock absorber mounting bracket, increase strength of an input point of a shock absorber, and effectively dispense a load of the shock absorber.

2. Description of Related Art

In general, a rear vehicle body of a conventional vehicle is provided with a rear floor panel, and a rear wheel housing for installing a shock absorber of a rear suspension and a wheel is coupled to left and right front portions of the rear floor panel.

A quarter inner panel forming both lateral portions of the vehicle is coupled to the outside of the upper end of the rear wheel housing. A package tray front-side panel and a package tray rear-side panel are coupled to the inside of the quarter inner panel to support a package tray, and a shock absorber mounting bracket for mounting a shock absorber is coupled to the outside of the upper portion of the rear wheel housing.

The shock absorber mounting bracket 10 in the related art has an upper portion which is supported by a quarter outer upper reinforcement 30 provided on the upper portion of the rear wheel housing 20, and a lower portion supported by an outer reinforcing member 40, as shown in FIG. 1, to increase the strength of an input point of the shock absorber.

The lower portion f the outer reinforcing member 40 is provided with a rear spring seat mounting bracket 50.

However, the shock absorber mounting bracket 10 in the related art has a strong support force in upward and downward direction, but has a weak support force in a traveling direction of the vehicle and generates vibration and noise heavily.

The information disclosed in this Background section is only for enhancement of understanding of the general background of the invention and should not be taken as an acknowledgement or any form of suggestion that this information forms the prior art already known to a person skilled in the art.

### SUMMARY OF INVENTION

Accordingly, the present invention has been made to address the above-mentioned problems occurring in the prior art while advantages achieved by the prior art are maintained intact.

Various aspects of the present invention provide for a shock absorber mounting bracket reinforcing structure including reinforcing members provided on both sides of a shock absorber mounting bracket, in which the reinforcing members extend to enclose an upper portion, lateral portions and a lower portion of the shock absorber mounting bracket to considerably increase support strength of the left and right sides of the shock absorber mounting bracket, effectively dispense a load of a shock absorber, increase strength of an input point of the shock absorber, and reduce generation of vibration and noise.

In one aspect of the present invention, there is provided a shock absorber mounting bracket reinforcing structure including a shock absorber mounting bracket provided at a rear wheel house inner panel, and left and right reinforcing members which are provided on left and right sides of the shock absorber mounting bracket to support the left side and the right side of the shock absorber mounting bracket.

The left and right reinforcing members may include an upper portion extending to enclose an upper portion of the shock absorber mounting bracket through left and right portions of the shock absorber mounting bracket, and a lower portion extending to a rear wheel housing inner panel through a lower portion of the shock absorber mounting bracket.

The lower portion of the left reinforcing member may be provided with a rear spring seat mounting bracket.

The upper portions of the left and right reinforcing members may extend to enclose the upper portion of the shock absorber mounting bracket.

The left and right reinforcing members may be formed in an n-shaped cross section.

According to the present invention, the shock absorber mounting bracket reinforcing structure includes the reinforcing members provided on both sides of a shock absorber mounting bracket, and the reinforcing members extend to enclose the upper portion, the lateral portions and the lower portion of the shock absorber mounting bracket, thereby increasing considerably support strength of the left and right sides of the shock absorber mounting bracket, effectively dispensing a load of the shock absorber mounting bracket, increasing strength of an input point of a shock absorber, and reducing generation of vibration and noise.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a view illustrating a shock absorber mounting bracket reinforcing structure in the related art.

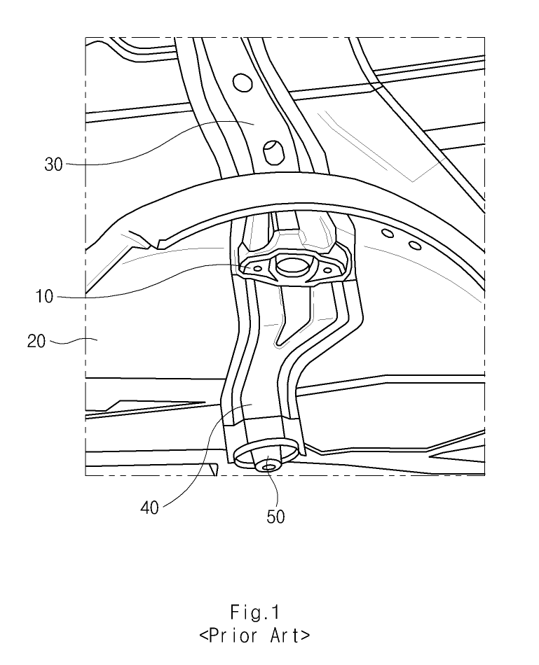

FIG. 2 is a perspective view illustrating an exemplary shock absorber mounting bracket reinforcing structure according to the present invention.

FIG. 3 is a side view illustrating an exemplary shock absorber mounting bracket reinforcing structure according to the present invention.

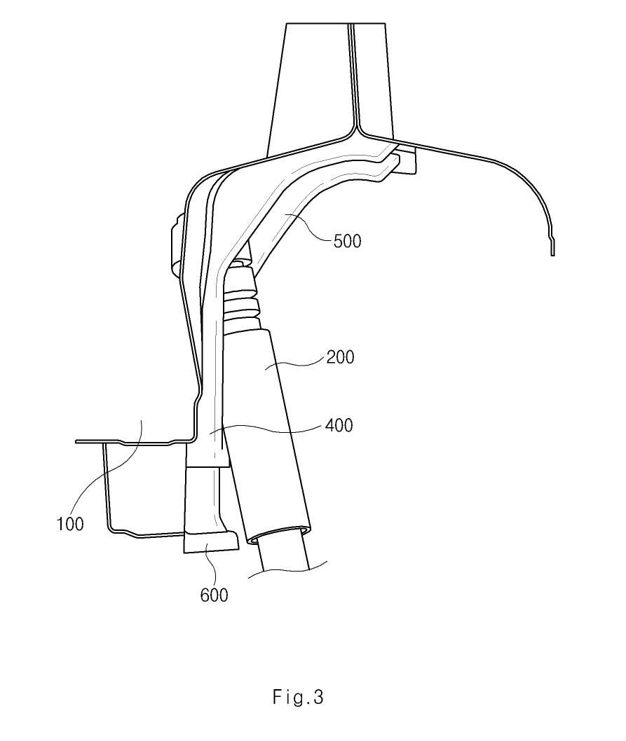

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

A shock absorber mounting bracket reinforcing structure includes a shock absorber mounting bracket 300 provided at an upper portion of a rear wheel house inner panel 100, and left and right reinforcing members 400 and 500 which are provided on left and right sides of the shock absorber mounting bracket 300 to support the left side and the right side of the shock absorber mounting bracket 300. A rear shock absorber 200 is mounted on the shock absorber mounting bracket 300.

The left and right reinforcing members 400 and 500 are formed in an n-shaped cross section. Opened portions of the left and right reinforcing members 400 and 500 are attached to the rear wheel house inner panel 100, and the left and right reinforcing members 400 and 500 are closely attached to the left and right portions of the shock absorber mounting bracket 300.

That is, upper portions of the left and right reinforcing members 400 and 500 extend to enclose an upper portion of the shock absorber mounting bracket 300 through the left and right portions of the shock absorber mounting bracket 300, and lower portions extend to the rear wheel housing inner panel 100 through a lower portion of the shock absorber mounting bracket 300.

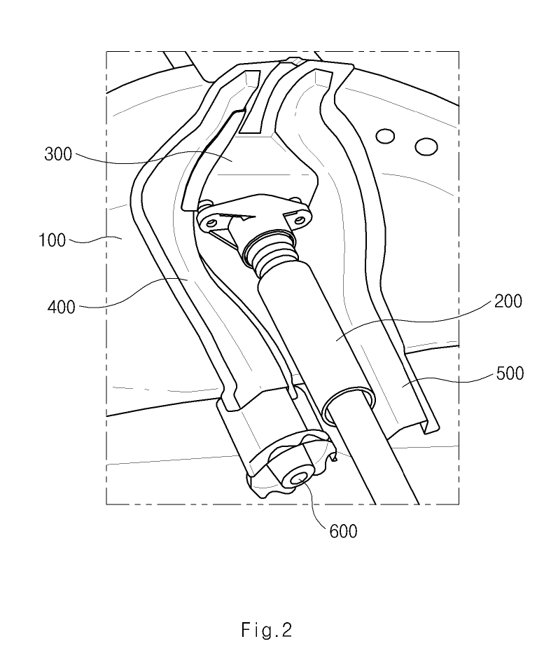

In other words, the left and right reinforcing members 400 and 500 are closely attached to the shock absorber mounting bracket 300 except for the upper and lower portions, as shown in FIG. 2, so that the left and right reinforcing members 400 and 500 reinforce the strength of the upper portion, the lower portion and the lateral portions of the shock absorber mounting bracket 300.

The lower portion of the left reinforcing member 400 is provided with a rear spring seat mounting bracket 600.

With the shock absorber mounting bracket reinforcing structure according to the present invention, since the left and right reinforcing members 400 and 500 are provided to enclose the left and right sides of the shock absorber mounting bracket 300, thereby increasing considerably support strength of the left and right sides of the shock absorber mounting bracket. Therefore, a load of the shock absorber mounting bracket can be effectively dispensed, and thus vibration and noise can be remarkably reduced.

For convenience in explanation and accurate definition in the appended claims, the terms left and right, upper or lower, front or rear, and etc. are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A shock absorber mounting bracket reinforcing structure comprising:
a shock absorber mounting bracket provided at an inner panel of a rear wheel house; and
left and right reinforcing members provided on left and right sides of the shock absorber mounting bracket, respectively, to support the left side and the right side of the shock absorber mounting bracket.

2. The shock absorber mounting bracket reinforcing structure according to claim 1, wherein the left and right reinforcing members include an upper portion extending to enclose an upper portion of the shock absorber mounting bracket through left and right portions of the shock absorber mounting bracket, and a lower portion extending to a rear wheel housing inner panel through a lower portion of the shock absorber mounting bracket.

3. The shock absorber mounting bracket reinforcing structure according to claim 2, wherein the lower portion of the left reinforcing member is provided with a rear spring seat mounting bracket.

4. The shock absorber mounting bracket reinforcing structure according to claim 2, wherein the upper portions of the left and right reinforcing members extend to enclose the upper portion of the shock absorber mounting bracket.

5. The shock absorber mounting bracket reinforcing structure according to claim 1, wherein the left and right reinforcing members are formed in an Π-shaped cross section.
